(19) United States
(12) Patent Application Publication
(10) Pub. No.: US 2025/0158448 A1
(43) Pub. Date: May 15, 2025

(54) HYBRID POWER SYSTEMS AND METHODS

(71) Applicant: PGA TOUR, Inc., Ponte Vedra Beach, FL (US)

(72) Inventors: Jonathan Rabhan, Ponte Vedra Beach, FL (US); Scott Ross, Ponte Vedra Beach, FL (US); Barry Walker, Ponte Vedra Beach, FL (US); Bryan Lenz, Ponte Vedra Beach, FL (US); Gregory Young, Ponte Vedra Beach, FL (US); Jonas Gredenhag, Ponte Vedra Beach, FL (US); Walter Lovell, Ponte Vedra Beach, FL (US)

(73) Assignee: PGA TOUR, Inc., Ponte Vedra Beach, FL (US)

(21) Appl. No.: 18/510,522

(22) Filed: Nov. 15, 2023

(51) Int. Cl. H02J 13/00; A63B 71/06; H02J 7/35

(52) U.S. Cl. CPC H02J 13/00034; H02J 7/35; H02J 13/00002; H02J 13/00022; A63B 71/0616; H02J 13/00001; H02J 2300/24

(57) ABSTRACT

A hybrid power system for providing power to a golf tournament includes a power module including a case for housing a battery. Input and output ports are provided to receive and output power with respect to the battery. A control system is provided to monitor statuses and conditions of the power module and includes a controller to execute operations of the power module. A communication port is included to provide electronic communicate with a communication network. The module includes a remote interface accessible via the communication network and configured to interface a monitoring station with the control system and receive or access monitored data collected by the control system related to the operations of the power module. A solar array may be included that couples to one of the one or more input ports.

### TECHNOLOGY

The present disclosure is directed to power systems for provided power to powered devices. More specifically, the present disclosure is directed to mobile power systems and power systems capable of one or more of autonomous operation, expansion, flexible charging, or networking with remote control capabilities.

### BACKGROUND

Refined tracking of golf tournament play requires hundreds to thousands of miles of cables to connect the various tracking and supporting equipment such as cameras, radar, digital signage, and networking related equipment. Among the cables are power cables used to power such equipment. If practicable, the power cables may be run from a grid connection. Even when practicable, power cables will typically need to be laid long distances over variable terrain and through areas that may experience traffic from players, spectators, and tournament support personnel and vehicles. This placement increases the opportunity for the cables to be damaged by traffic and weather. An alternative to power supplied by the grid, is to provide one or more generators around the golf course. However, a drawback to utilizing generators is that generators have a large footprint, are loud, and their use often requires running power cords long distances from the generator to the equipment load. Generators also require a fueling infrastructure that creates potential for hazardous conditions as well as noise and other challenges to golf tournament operations. What is needed are improved solutions to providing power to dispersed locations around a golf course.

### SUMMARY

In one aspect, a hybrid power system for providing power to a golf tournament includes a power module including a case for housing a battery. Input and output ports are provided to receive and output power with respect to the battery. The power module includes a control system is provided to monitor statuses and conditions of the power module and includes a controller to execute operations of the power module. A communication port is configured to provide electronic communicate with a communication network. The power module includes a remote interface accessible via the communication network and configured to interface a monitoring station with the control system and receive or access monitored data collected by the control system related to the operations of the power module. A solar array may be included that couples to one of the one or more input ports.

In one embodiment, the solar array is configured to position over and at least partially enclose the power module.

In the above or another embodiment, the solar array comprises three panels that wrap around legs of a tripod. The power module may be sized and configured to position within an area defined between the legs of the tripod.

In any of the above or another embodiment, the remote interface is accessible via wireless communication to remotely view monitored data comprising statuses and conditions related to the operation of the power module.

In a further embodiment, the statuses and conditions comprise one or more of an environmental condition, operational state, load, battery capacity, or security access log.

In any of the above or another embodiment, the control system includes predefined trigger conditions that trigger actions based on monitored operating conditions.

In a further embodiment, the actions comprise transmitting a notification of the condition triggering the action to the monitoring station.

In any of the above or another embodiment, the remote interface is accessible via wireless communication by the monitoring station to remotely control operations of the controller.

In a further embodiment, the controller is operable to engage breakers within battery input and output power circuits.

In a further embodiment, the controller is operable to one or more of modify electrical current output, redirect electrical current to one or more out ports, redirect charging current to one or more battery cells, or initiate and discontinue operation of a fan located within the case or a vent thereof.

In any of the above or another embodiment, the control system is configured to perform one or more of temperature monitoring, battery monitoring and management, moisture monitoring, water remediation, or case security.

In any of the above or another embodiment, the control system includes one or more sensors comprising one of a moisture sensor or humidity sensor configured to detect a moisture level within the case.

In a further embodiment, the sensors comprise a temperature sensor configured to measure temperature within the case, temperature of power module hardware within the case, or both.

In any of the above or another embodiment, a fan is located with the case or at a vent thereof and the controller is configured to initiate operation of the fan when the moisture level or temperature exceeds a predefined threshold.

In any of the above or another embodiment, a local interface is positioned on the case and includes controls for engaging or disengaging breakers within battery input and output power circuits.

In a further embodiment, the local interface includes a view window for viewing a network activity indicator light.

In another aspect, a monitoring network for monitoring a plurality of mobile power modules positioned around a golf course to provide power to cameras and radar includes a monitoring station off-site of the golf course configured to wirelessly communicate with the plurality of power modules to receive or access monitored data with respect to the power modules, remotely control one or more operations of the power modules, and receive notifications. The power module includes a case for housing a battery. Input and output ports are provided to receive and output power with respect to the battery. The power module includes a control system is provided to monitor statuses and conditions of the power module and includes a controller to execute operations of the power module. A communication port is configured to provide electronic communicate with a communication network. The power module includes a remote interface accessible via the communication network and configured to interface with monitoring station with the control system and receive or access the monitored data collected by the control system related to the operations of the power module. A solar array may be included that couples to one of the one or more input ports.

In one embodiment, the monitored data comprises statuses and conditions related to the operation of the respective power modules.

In a further embodiment, the statuses and conditions comprise one or more of an environmental condition, operational state, load, battery capacity, or security access log.

In yet another aspect, a method of providing remote power on a golf course during a golf tournament includes providing a plurality of power modules for positioning around the golf course; wirelessly communicating with a control system of each of the power modules to receive or access monitored data relating to the operation of the respective power modules; remotely controlling one or more power input or power supply operations of at least one of the power modules via communication with the control system of the at least one of the power modules. Each of the power modules includes a case for housing a battery. Input and output ports are provided to receive and output power with respect to the battery. A control system is provided to monitor statuses and conditions of the power module and includes a controller to execute operations of the power module. A communication port is configured to provide electronic communicate with a communication network. Each power module further includes a remote interface accessible via the communication network and configured to interface with monitoring station with the control system and receive or access the monitored data collected by the control system related to the operations of the power module. A solar array may be included that couples to one of the one or more input ports.

In one embodiment, the monitored data comprises statuses and conditions related to the operation of the respective power modules, and statuses and conditions comprise one or more of an environmental condition, operational state, load, battery capacity, or security access log.

### DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 schematically illustrates a hybrid power system in communication with a monitoring network according to various embodiments herein;

FIG. 2 schematically illustrates a local interface of a power module according to various embodiments described herein;

FIGS. 3A-3E illustrate charging and capacity expansion arrangements of a power module 20 according to various embodiments herein;

FIG. 4 illustrates a hybrid power system powering a device according to various embodiments herein;

FIG. 5A illustrates a rear side view of a power module according to various embodiments herein;

FIG. 5B illustrates a front side view of a power module according to various embodiments described herein;

FIG. 6A illustrates a local interface of a power module according to various embodiments herein;

FIG. 6B illustrates a display of a local interface of a power module according to various embodiments herein;

FIG. 7 schematically illustrates a battery circuit including charge and power output features of a power module according to various embodiments herein;

FIG. 8 illustrates a solar array according to various embodiments described herein; and

FIG. 9 schematically illustrates a monitoring network in communication with a plurality of hybrid power systems located at different geographic locations according to various embodiments herein.

### DESCRIPTION

The present description discloses hybrid power systems and methods of using hybrid power systems, particularly in a golf tournament environment. The hybrid power system may include a power module and solar array that combine to provide power management and energy storage into a single system. The hybrid power system may be configured to be rugged and portable. The hybrid power system may beneficially be expandable to provide flexibly to users with respect to number of units, power capacity, and connections. In one embodiment, the power module may be universally compatible with single phase AC inputs (90-270 VAC) allowing connection to any generator or worldwide grid AC power source. In this or another embodiment, the power module may be configured to accept power from DC generation sources, which may include regulated DC power sources.

The hybrid power system may be configured to include any desired combination of power output ports and input ports to provide unique capabilities and flexibility in its application. These may include AC, DC or other power configurations. When employing the solar array, the hybrid power system may provide a fully-autonomous power system.

The hybrid power system may find use in independent single unit applications or multi-unit applications. For example, the hybrid power system may be operated as one or more power modules and solar arrays at a single location or multiple power modules and solar arrays distributed about a geographic area. The hybrid power system may provide a remote interface accessible to users to remotely view statuses and conditions related to the operation of the power module such as one or more of environmental conditions, operational states, loads, capacities, security, such as a security access log, capabilities, features, or the like. In one embodiment, users may access the remote interface to control operations of the power module, as described in more detail below. Multiple hybrid power systems may be networked to allow users to remotely monitor one or more of environmental conditions, operational states, loads, capacities, security, capabilities, features, or the like.

The hybrid power system may be used indoors or outdoors, including hybrid indoor and outdoor applications wherein one or more units operate within an indoor environment and one or more units operate in an outdoor environment. Outdoor applications may beneficially take advantage of solar power generation capabilities. Hybrid power systems may be deployed in emergency or backup power applications, military applications, mobile restaurant or commercial applications, expos, conferences, festivals, carnivals, circuses, concerts, and sporting applications, such as professional, amateur, or youth sporting events, including golf tournaments, automotive racing, boat racing, RC racing or other hobbyist gatherings, marathons, triathlons, track meets, baseball, softball, soccer, American football, lacrosse, volleyball, gymnastics, swim meets, to name a few.

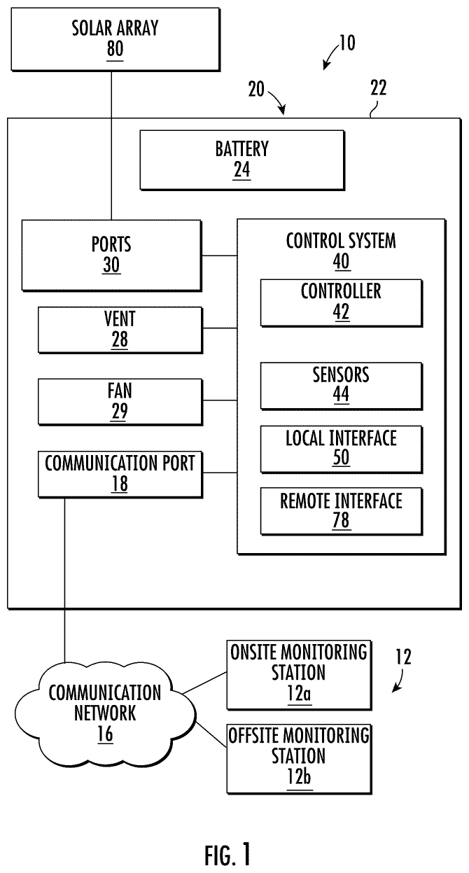

FIGS. 1-9 illustrate various embodiments of a hybrid power system 10, hybrid power system 10 components, and systems and devices that may interact with the hybrid power system 10, wherein like numbers indicate like features.

With particular reference to FIG. 1, which schematically illustrates a hybrid power system 10 in communication with a monitoring network 12 according to various embodiments herein, a hybrid power system 10 may include a power module 20. The power module 20 may include a case 22 that houses a battery 24 and various components of the power module 20. The battery 24 may utilize battery technologies such as wet battery, dry cell, lead acid, alkaline, lithium, lithium ion, lithium iron phosphate, lithium nickel cobalt aluminum oxide, lithium nickel manganese cobalt oxide, lithium sulfur, zinc-carbon, or other future developed battery technologies. In one example, the battery 24 comprises a lithium iron phosphate battery, such as a 1.6 kW lithium iron phosphate battery.

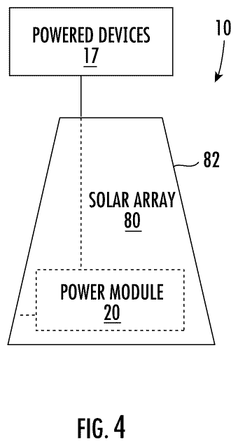

The power module 20 may be configured to accept power from multiple sources. For example, the power module 20 may be configured to accept power from one or more of DC generation sources, such as regulated DC power sources, AC power sources such as single phase AC inputs (90-270 VAC) allowing connection to any generator or worldwide grid AC power source. The power module 20 may be configured to output power in any desired current type to power powered devices (see. FIG. 4).

The hybrid power system 10 may include or be configured to electrically couple to a solar array 80. The solar array 80 may comprise one or more panels 82 (see FIG. 4) including photovoltaic cells or other methods configured to convert solar energy into direct current electricity. In one example, the one or more panels 82 comprise thin-film solar photovoltaic panels. The solar array 80 may be operable to supply power to the power module 20 that is used to charge the battery 24. Incorporation of a solar array 80 to charge the battery 24 enables the hybrid power system 10 to operate in an autonomous mode when sufficient sunlight is available to provide a supply of power to charge the battery 24 and offset power output from the battery 24.

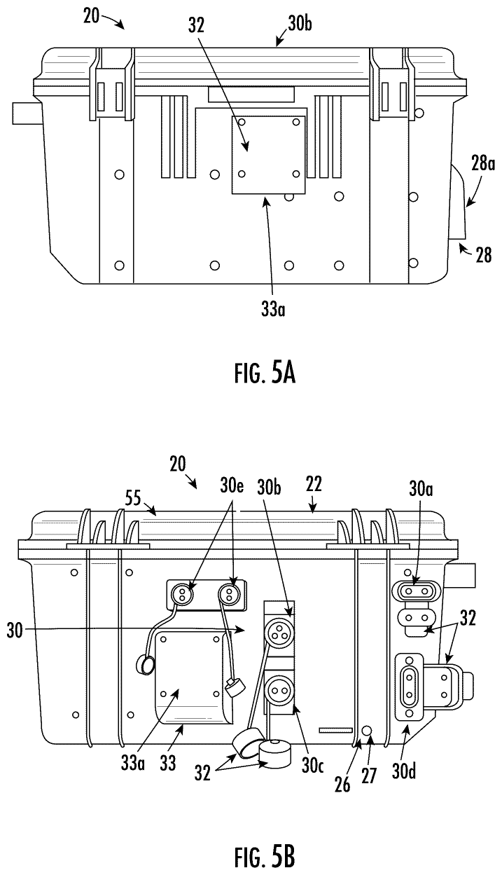

The case 22 is preferably constructed of a rugged material configured to withstand shock and outdoor conditions. When the case 22 is rated for outdoor applications, the case 22 is preferably resistance to water intrusion. The case 22 may include an interior access port that may be exposed or covered via an access door. A water resistance seal may be positioned along an interface of the access port and access door to prevent water intrusion via the access port when the access door is in the covered position. In the covered position, the access door may be secured to the access port via latches, locks, clips, bolts, or other suitable securing mechanism. In some embodiments, the case 22 is equipped with drain 26 and drain plug 27 (see FIG. 5B). In one example the drain plug 27 is accessible from the exterior side of the case 22 to allow users to open and close the drain 26. In this or another embodiment, the case 22 may be further equipped with an actuator operable to open and close the drain 26. The actuator may be under the control of a controller 42, as described in more detail below. When so equipped, actuation of the drain plug 27 may be automated via the occurrence of a trigger condition, manually commanded locally via a local interface 50, manually commanded remotely via a remote interface 78, or combination thereof.

The case 22 may include a plurality of ports 30 configured to provide connection points for operations of the power module 20. For example, the ports 30 may include i/o ports, input ports such as charge ports to connect to a supply of power to charge the battery 24, output ports to devices to be powered, or controller access ports to access operations of the controller 42 or control system 40, which may include networking ports, programming ports, or diagnostic or test ports. In some embodiments, diagnostic ports may be provided for specific systems or hardware. In one example, the power module 20 includes one or more ports 30 for connecting to life support systems to power the same. The type of ports 30 utilized may be selected for the desired end use. For example, for golf tournament application, the power module 20 may include ports 30 for connecting power to one or more of radar, lasers, or cameras. Ports 30 accessible along an exterior of the case 22 may be equipped with waterproof or water resistant caps to prevent water intrusion when not in use.

The power module 20 may include one or more vents 28 to provide air flow between the interior of the case and the exterior environment. For example, one or more intake vents may be provided on the case 22 between the interior and exterior to intake air. One or more exhaust vents may also be provided between the interior and exterior to exhaust air from the interior of the case 22. An intake vent may be located relative to an exhaust vent such that air that is moved through the intake vent flows across hardware to be cooled by the air prior to exhausting through the exhaust vent. For example, an intake vent may be positioned on an opposite side of the case 22 from an exhaust vent. In one embodiment, filters may be provided with one or more vents 28. The filters may be configured to filter air that passes through the vent 28. Vents 28 may be configured with moisture intrusion prevention features to prevent or limit water intrusion. For example, vents 28 may include a vent cover or moisture trap to prevent water entering the vent 28 from flowing into the portion of the interior of the case 22.

In some embodiments, the power module 20 includes one or more fans 29. Fans 29 may be associated with vents 28 to assist in pulling or exhausting air with respect to the interior of the case 22. Additionally or alternatively, one or more fans 29 may be positioned within the interior of the case 22 to pull or direct air flow with respect components to be cooled.

In one embodiment, the case 22 may be equipped with a viewing window 51 along an exterior facing side of the case 22 to allow a user to view an interior portion of the case 22, e.g., to view housed hardware or operation indicators. In one example, a window 51 is provided to allow users to view network activity indicator lights within the interior of the case 22. A network switch (not visible) may be provided to engage or disengage network activity.

The hybrid power system 10 may be equipped with a control system 40 configured to monitor and execute operations of the hybrid power system 10. The control system 40 may be configured to perform one or more of temperature monitoring and control, battery monitoring and management, moisture monitoring, water remediation, case security, local communication, remote communication, or combination thereof. The control system 40 may include a controller 42 to execute operations of the control system 40. The controller 42 may include a processor and a memory storage device. The memory storage device may include instructions that when executed by the processor perform operations of the controller 42. The instructions may define operating conditions of the power module 20 and define triggers conditions for taking actions based on the monitored operating conditions, such as discontinuing supply of electrical current, modifying electrical current output, redirecting electrical current to one or more out ports, redirect charging current to one or more battery cells, turn the fan on or off, engaging breakers, outputting notifications regarding monitored operations, outputting notifications comprising warnings regarding monitored operations, or other actions, such as those described herein. The controller 42 will typically be housed within the case 22 but may be housed on an exterior side of the case 22 or be provided separately for connection to the case 22 components, e.g., via a port or other suitable connections. The controller 42 may include one or more controller 42 boards. In one example, a controller 42 board includes a single board computer.

Operation conditions associated with the monitored data may include battery 24 condition, such as one or more of state of charge, battery 24 health, charge current, discharge current (e.g., current, minimum, maximum), solar wattage generated, amp draw of a load, battery 24 temperature (e.g., current, minimum, maximum), board temperature, voltage (e.g., current, total, individual cells, minimum, maximum), discharge rate, time to discharge, or combination thereof. Some embodiments may further include operation conditions associated with the monitored data selected from one or more of temperature within the case 22 or with respect to components within the case 22, case 22 moisture intrusion, case 22 humidity, or the like. In some embodiments, operation conditions associated with the monitored data include access door status, port status, detected access to the local interface 50, e.g., access door opened, or access to the interior of the case 22. Operation conditions associated with the monitored data may include estimated time until the battery 24 is fully charged or charged to a specified capacity. Operation conditions associated with the monitored data may include current operation state or metrics with respect to one or more systems. In one embodiment, operation conditions associated with the monitored data may include port status, e.g., state of one or more individual ports, which in one example includes operational metrics associated therewith. For instance, the controller 42 may detect connection status of one or more ports 30. The controller 42 may further detect operational metrics with respect to individual ports such as amp draw from a load connected to the port. In various embodiments, the control system 40 may be programmed to operate autonomously, receive instructions from and be controllable by the monitoring network 12, or manually interfaced by a user, e.g., via the local interface 50, or combination thereof. For instance, an onsite monitoring station 12a or offsite monitoring station 12b may interface with the control system 40 via wired or wireless connection with the communication port 18 to provide control instructions, e.g., switch powered devices on or off. In a further embodiment, the control system 40 may provide the monitoring network 12 access to operations of connected devices, e.g., powered devices 17, such as cameras, radar, or both, via a same or different communication port 18. For example, the monitoring network 12 may connect to network ports via wired or wireless connections to monitor statuses or operations of connected devices or control connected devices. The communication port 18, or network ports thereof, may be provided on an exterior of the case 22, on the local interface 50, or both.

The control system 40 may include sensors 44 configured to detect operation conditions with respect to the power module 20, solar array 80, or both. Sensors 44 may include sensors 44 configured to measure current, charge, voltage, battery 24 temperature, case 22 temperature, humidity, or other sensors 44, including those described herein. Temperature or humidity sensors 44 configured to measure temperature or humidity within the case 22 may be positioned within the case 22. Sensors may include circuits, which may be associated with the controller 42, configured to detect battery 24 conditions, which may include charge current, discharge current, voltages, battery 24 temperature, or the like. In one embodiment, the control system includes or employs an interface to the solar charge controller to measure and report solar wattage generated. In one embodiment, the controller 42 includes or employs a Controller Area Network (CAN bus). The CAN bus may provide refined monitoring of the battery 24, including one or more of state of charge, battery 24 health, charge current, discharge current (e.g., current, minimum, maximum), amp draw of a load, battery 24 temperature (e.g., current, minimum, maximum), board temperature, voltage (e.g., current, total, individual cells, minimum, maximum), discharge rate, time to discharge, or combination thereof.

Upon receipt of the monitored data, the control system 40 may analyze the data and determine if the data alone or together with additional monitored data requires action. For example, as introduced above, the control system 40 may be programmed to take action upon the occurrence of a condition defined as a trigger condition determined from the monitored data. The control system 40 may be configured to log monitored operational conditions over time. The control system 40 may time stamp monitored data, which may include operational metrics, for analysis or review.

The hybrid power system 10 may include or incorporate a monitoring network 12. The monitoring network 12 may include onsite monitoring stations 12a, offsite monitoring stations 12b, or both. The hybrid power system 10 may be configured to provide access to the operations of the control system 40 to the monitoring network 12 via a communication port 18 configured for data communication via wired or wireless communication technologies, such as point to point, multi-point, WAN, LAN, PAN, Bluetooth protocol, cloud, distributed, or WiFi. For example, the control system 40 may provide a remote interface 78 wherein monitoring stations may view monitored data, operational conditions, statuses, or the like. In a further example, the remote interface 78 may provide access to one or more operations of the controller 42, such as one or more of the operations of the controller 42 described herein.

The control system 40 may be configured to perform battery 24 management operations. For example, utilizing the controller 42, the control system 40 may monitor battery 24 conditions and control various aspects of power input, output, battery 24 health, safety, or combination thereof. In one embodiment, the control system 40 is configured to utilize the controller 42 to manage various battery 24 functions, including monitoring current in and out of the battery 24, voltage, which may be to the cell level, temperature, state of charge, battery health, or the like. For example, the control system 40 may include temperature sensors 44 that detect temperatures associated with the battery 24. As noted above, the controller 42 may include a CAN Bus for refined battery monitoring and management to the cell level. Based on monitored temperatures and defined temperature conditions, the controller 42 may engage fans 29 to increase air circulation and reduce temperatures. Additionally or alternatively, the control system 40 may include a temperature sensor and circuitry that thermostatically control fans 29 to engage and disengage operation based on measured temperature. In some embodiments, the power module 20 is equipped with one or more protection circuits to protect the battery 24 and users from dangerous conditions related to cell voltages, temperatures, and current flowing in or out of the battery 24. The controller 42 may include or otherwise be operable to one or more of monitor, engage, or disengage protection circuits. The battery 24 management operations may be designed to promote healthy cycling at the individual cell level. When all operating conditions are satisfactory, current can flow in/out of the battery 24 cells (cycling). If temperature, voltage, or current is outside of the defined operation condition limits, the controller 42 may engage protection circuits and remove the cells from service, disabling the battery 24 at its terminals until proper operating conditions are restored. This may include engaging fans 29 to circulate air and reduce temperature, modifying current to specific cells, or the like.

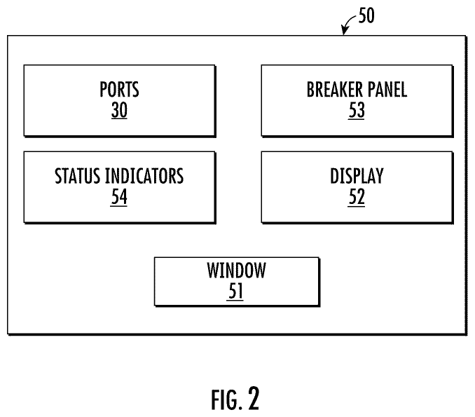

In some embodiments, the control system 40 is configured to perform water remediation operations. Water remediation operations may include moisture detection, moisture remediation, or both. For example, the control system may include one or more sensors 44 for detecting moisture. Moisture detection sensors may be positioned within the interior of the case 22 to detect moisture within the case 22. Moisture detection sensors may include humidity sensors, water sensors, or the like. Upon detection of water intrusion or other moisture condition, e.g., a high humidity condition, the control system 40 may be configured to perform one or more water remediation actions. In one example, the control system 40 may be configured to output a warning to users of the moisture condition. The warning may be output locally via a local interface 50, which may include output warning sounds, activation of warning lights, warning messages on a display 52 (see FIG. 2) of the local interface 50, or combination thereof. The warning may identify the trigger condition, parameters triggering the condition, recommended actions to be taken, or combination thereof. In one example, warnings messages may provide instructions to respond to the condition, such as open drain plug 27, engage fans 29, engage a dehumidifier (if so equipped), shut down operation of one or more powered devices 14, discontinue battery charge, engage breaker circuits, or combination thereof. In an above or another embodiment, the control system 40 may be configured to automatically take action upon detection of a water intrusion or other moisture condition. For example, the controller 42 may modify or shut down operation of one or more ports 30, battery cells, or circuits in response to a moisture condition. In a further or another example, the controller 42 may be configured to engage one or more fans 29 in response to a moisture condition. In an embodiment that includes a dehumidifier, the controller 42 may be configured to engage the dehumidifier upon detection of a moisture condition. In one embodiment including a drain plug 27 and a drain plug 27 actuator, the controller 42 may open the drain plug 27 in response to a moisture condition. Thus, upon detection of a moisture condition, the control system 40 may additionally or alternatively be configured to trigger the controller 42 to respond to the condition, e.g., by engaging one or more breaker circuits or otherwise shutting down or modifying one or more operations of the power module 20 or battery cells, or when, so equipped, one or more of engaging fans 29, opening a drain plug 27, or engaging a dehumidifier, depending on the condition and severity.

As introduced above, and with further reference to FIG. 2, the power module 20 may include a local interface 50. The local interface 50 may be provided on an exterior side of the case 22. In one example, the local interface 50 is provided with an access door that may be used to cover the local interface 50 when access to the local interface 50 is not needed. The local interface 50, access door, or both may be configured with a water resistant seal to prevent or limit water intrusion into the interior of the case 22, onto the local interface 50, or both. The local interface 50 may include a breaker control panel 53 for engaging and disengaging breakers to power module components, ports 30 or powered devices 17 connected to the power module 20 via the ports 30, battery 24, or combination thereof. For example, the local interface 50 includes controls for engaging or disengaging individual breakers with batter input and output power circuits. In some embodiments, the local interface 50 includes status indicators 54. Status indicators may include lights, display screens, or the like. Status indicators may be included to provide users quick reference to system statuses, such as breaker statuses, network statuses, or other operational statuses. The local interface 50 may also include one or more ports 30. The ports 30 may include administrative ports or other data or control ports for accessing operations of the power module 20 or connected powered devices 17. For example, ports 30 may include networking ports, communication ports, controller access ports, local interface power output ports, radar ports, access point (AP) ports, accessory power ports, or the like. The local interface 50 may include one or more displays 52 to display operation conditions, such as one or more of statuses of system components or operations, trigger conditions, monitored data, date, time, power module identification number, or notifications comprising warnings, warning messages, or network status, instructions to address trigger conditions.

In some embodiments, the control system 40 includes sensors 44 to detect access to the local interface 50. The sensors 44 may detect when the access door is opened, closed, or both. The sensors 44 may include motion sensors, light sensors, mechanical sensors, magnets, or other suitable sensors to detect an open or closed relationship between the case 22 and the access door. In one example, the control system 40 may be configured to track access instances. The control system 40 may generate a log of access instances. In a further example, the control system 40 may timestamp access instances. In a further or another example, the control system 40 may transmit access instances via the communication port 18 to the monitoring network 12, e.g., onsite monitoring station 12a, offsite monitoring station 12a, or both. Additionally or alternatively, the control system 40 may be configured to monitor access instances wherein onsite monitoring stations 12a, offsite monitoring stations 12b, or both may access tracked access instances, e.g., an access log, current access status, or both.

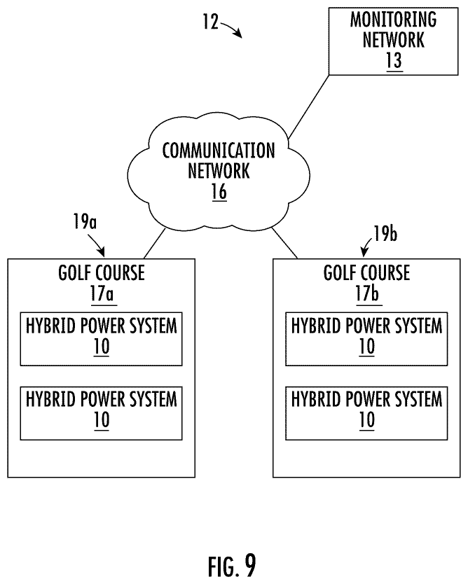

In some embodiments, the control system 40 may be configured to continuously, periodically, upon the occurrence of a trigger condition, or combination thereof, display monitored data on a screen of the display 52. Monitored data may include metrics, operational conditions, statuses, fault warnings, or warning messages based on the monitored data. For instance, the control system 40 may be configured to cause monitored data such as state of charge, state of health, faults, or combination thereof to be displayed on the display. The control system 40 may additionally or alternatively cause activation of status indicators 54, such as illumination of lights or sound output from speakers, to provide notification of the monitored data. Additionally or alternatively, the control system 40 may be configured to transmit, via the communication port 18, one or more components of the monitored data to the network to report the same. The monitored data may be transmitted locally to an onsite monitoring station 12a, remotely to an offsite monitoring station 12b. Onsite monitoring stations 12a and offsite monitoring stations 12b may monitor a plurality of power modules 20. For example, an offsite monitoring station 12b of a monitoring network 12 may be configured to receive monitored data from power modules 20 positioned around one or more golf courses 17a, 17b located at one or more geographic locations 19a, 19b (see FIG. 9). Monitoring stations 12a, 12b may be configured to access monitored data for analysis. As introduced above, the control system 40 may provide a remote interface 78 accessible by one or more monitoring stations 12a, 12b of a monitoring network 12 to access some or all of the monitored data. For instance, the remote interface 78 may provide access to statuses such as state of charge, battery health, battery or system faults, port status, network status, or other statuses. The remote interface 78 may also provide access to one or more operational conditions, such as those described herein. In a further example, the control system 40 may be configured to provide access to one or more of the operations of the controller 42 described herein via the remote interface 78. For example, using the remote interface 78, one or more monitoring stations 12a, 12b of a monitoring network 12 may transmit instructions to control systems 40 to take specific actions, such as modify power output, engage or disengage breakers, engage or disengage protection circuits, modify or discontinue power to one or more ports 30, run status checks, transmit current or historical statuses, engage fans, or other suitable action. One or more monitoring stations 12a, 12b of a monitoring network 12 may contact local personnel to inspect, test, confirm statuses, shut down, or take other action with respect to a power module 20 based on monitored data.

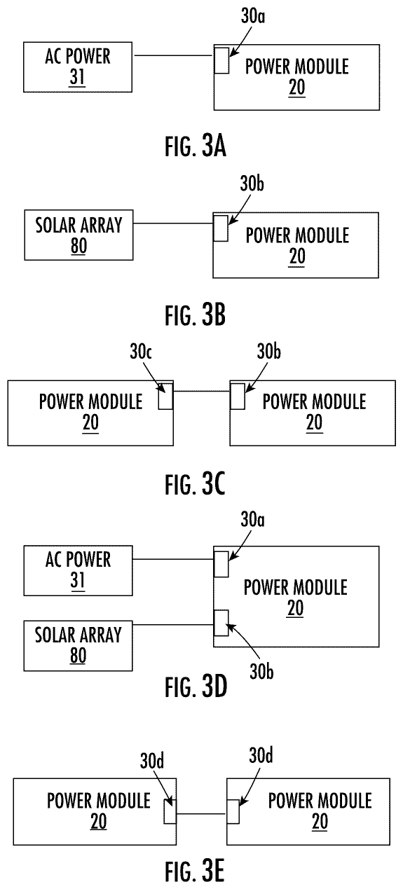

The power module 20 may be configured to provide flexible charging options. The power module 20 may be equipped with multiple charging options. For example, with further reference to FIG. 3A, the power module 20 may include an AC input port 30a for receiving a supply of AC from an AC power source 31, e.g., grid power or generator. The AC input port 30a may be operable as a charge port to supply the AC to the battery 24 to charge the same. An AC/DC charger may be positioned along a branch circuit between the AC input port 30a and battery 24 to receive the AC and charge the battery 24. With reference to FIG. 3B, the power module 20 may additionally or alternatively include a DC input port 30b to receive DC to charge the battery 24. The DC may be supplied from a solar array 80 connected to the DC input port 30b. A solar charge controller may be positioned with a branch circuit to receive the current from the solar array 80 and control the charge current to the battery 24. When connected to a solar array 80, the hybrid power system 10 may operate in an autonomous mode to provide a continuous supply of power harvested from sun light.

With reference to FIG. 3C, multiple power modules 20 may be connected such that one of the power modules 20 acts as a power donor to charge the battery 24 of the other power module 20. In this example, the a first power module 20 (donor) may connect to a DC input port 30b of the second power module 20 to charge the battery 24 of the second power module 20. In one example, the power sent from the first power module 20 is passed through a DC/DC converter and from the first power module 20 from a DC output port 30c for supply to the second power module 20. In this or another example, a charge converter, which may be the same or similar to the solar charge converter described in FIG. 3B, may receive the power passed through the charge port of the second power module 20 before supply to the battery 24. FIG. 3D illustrates a further example wherein the hybrid power system 10 includes a solar array 80 connected to the power module 20 as described with respect to FIG. 3B and is simultaneously connected to a supply of AC power as described with respect to FIG. 3A to provide a flexible supply of power when solar power generation is insufficient.

FIG. 3E illustrates an example wherein multiple power modules 20 are connected to expand battery capacity. In this example, both batteries act as one for increased capacity, additional operation between recharges, and reduced depth of discharge. The power modules 20 are coupled between an input/output (i/o) port 30d comprising a parallel connection port.

In some embodiments, a power module 20 may be configured to be deployed as an uninterrupted power supply to provide effectively instantaneous protection from power interruptions by switching to stored energy in the battery 24 of the power module 20. For example, the power module 20 may connected between an AC power supply and load and utilize standby, on-line, line-interactive, DC power, hybrid, or other suitable uninterrupted power supply technology.

It is to be understood that power currents may be changed or modified such that that input ports may receive any desired current or combinations of currents for charging the battery 24. Similarly, any combination of output ports may be included with respect to current type, plug configurations, or the like. For example, in some embodiments, the power module 20 may be configured to convert direct current to alternating current of desired form for output to any number of output ports. The selection, of ports in number, arrangement, and location with respect to the case 22 may be modified as needed for compatibility for charging or powering purposes. Ports may similarly be modified for both input and output operations.

As introduced above, and with further reference to FIG. 4, the hybrid power system 10 may include a solar array 80. The solar array 80 may comprise one or more panels 82 including photovoltaic cells configured to convert solar energy into DC electricity. In one example, the one or more panels 82 comprise thin-film solar photovoltaic panels 82. In some embodiments, the solar array 80 may be configured to provide an enclosure or otherwise cover the power module 20. The solar array 80 may provide physical protection, increased security, or both with respect to the power module 20 and its connections. The solar array 80 includes multiple panels 82 configured to be arranged in various configurations. Solar arrays having multiple panels 82 may be configured to attach together to provide various shaped arrays. Panel attachment may be provided by various connectors such as clips, latches, snaps, zippers, hook and loop, press-fit, interference fit, magnets, or the like. Panels will typically electrically couple to the power module 20 as a unit of one or more panels 82, but, in some embodiments, one or more panels 82 may couple to the power module 20 separately.

In various embodiments, panels 82 of the solar array 80 may be configured to be arranged in a pyramid configuration of three or more sides. Panels 82 will not typically be included to form a base of such a pyramid configuration. Additionally or alternatively, the apex of the pyramid configuration may be open to assist in air circulation. Other solar array 80 configuration shapes may also be used, such as conical or convex or concave disc shaped. In some embodiments, the solar array 80 may be arranged in an omni directional array configuration to capture sunlight from any direction.

The solar array 80 may include or be configured to be arranged to provide ventilation within an interior portion of the array. For example, openings may be provided between panels 82, within panels 82, or adjacent to panels 82. In a pyramidal design, such as one similar to that illustrated in FIG. 4, the panels 82 may be configured such that an opening is provided along the base, apex, or both to provide a chimney effect for increased ventilation. In this for a further configuration, a breathable material, such as a breathable fabric may be provided along a lower edge of the array, about the apex, or both. The ventilation may be utilized to reduce the heat load inside the solar array 80 or arrangement thereof.

It is to be appreciated that while panels 82 are generally described herein as being configured for various arrangements, panels 82 may be provided in fixed arrangements. In some embodiments, panels 82 may be configured for modular use to allow a user to add or remove panels 82 to increase, decrease, or otherwise modify cell count, location, or both.

In some embodiments, the hybrid power system 10 may employ trackers that employ sensors to track the sun or incidence angle of sunlight to optimize energy generation. Trackers may be single or multi-axis trackers configured for autonomous operation. The trackers may orient the one or more solar panels 82, mirrors, reflectors, lenses, or the like. In one embodiment, tracking may include manual tracking wherein the controller 42 includes a robotic orientation system that may be controlled locally, remotely, or both by a user, e.g., via the local interface 50, remote interface 78, or both.

With further reference to FIGS. 5A & 5B, illustrating a power module 20 according to various embodiments described herein, A power module 20 may comprise a case 22 that houses a battery 24 (not visible). While other battery technologies may be used, such as those described herein, the battery 24 comprises a lithium iron phosphate battery 24. One example lithium iron phosphate battery 24 is a 1.6 kW lithium iron phosphate battery 24. The case 22 is constructed of a rugged composite plastic, such as fibre-reinforced plastic material, configured to withstand shock and outdoor conditions.

A plurality of ports 30 are provided along an exterior portion of the case 22 to provide connection points for operations of the power module 20. The ports 30 include one or more input ports 30a, 30b comprising charge ports for receiving a supply of charging power and one or more output ports 30c for outputting a supply of power. The ports 30 also include an i/o port 30d. While different combinations of ports 30 and current designations may be used, the illustrated case 22 includes one or more DC input ports 30b. As shown, a DC input port 30b is provided and includes a solar charge port for connecting to a solar array 80. The DC charge port 30b may also operate as a donor charge port for connecting to another power module 20 or battery 24 to receive a donor charge e.g., via a bayonet cable. In some embodiments, multiple DC input ports 30b are provided. The case 22 may also include one or more output ports for providing a supply of power from the battery 24. As shown, the case 22 includes a DC output port 30c for connecting to another power module 20 or battery 24 to provide a donor charge. The case 22 also includes an AC input port 30a for receiving a supply of AC power, e.g., from the grid or a generator. The case 22 also includes an i/o port 30d comprising a parallel connection port for coupling the power module 20 to a parallel connection port of another power module 20 to expand battery 24 capacity. The case 22 also includes one or more output ports for coupling loads, such as powered devices 17, to be powered by the battery 24. As shown, two output ports 30e for supplying power to a radar system. The power module 20 is configured to output DC from output ports 30e, but in other embodiments, the power module 20 may be configured to output AC from these or other output ports 30e. The case 22 also includes a drain 26 and drain plug 27 accessible from the exterior side of the case 22 to allow users to open and close the drain 26 to remove water intrusion. The ports 30 accessible along the exterior of the case 22 are equipped with waterproof or water resistant caps 32 to prevent water intrusion when not in use.

Cable passthroughs 33 are provided along the side of the case 22 for passing cables between the interior and exterior of the case 22. The cable passthroughs are partially covered by a louver 33a to prevent water intrusion from above and along lateral sides. In some embodiments, the cable passthroughs 33 may be covered with not in use or may operate as vent openings.

Vents 28 are provided on the case 22 between the interior and exterior to intake and exhaust air. In the illustrated embodiment, an intake vent 28a is shown. A corresponding exhaust vent (not visible) is provided on the opposite end of the case 22. The intake vent 28a and exhaust vent are provided with a louver cover 28b to prevent water intrusion from about and along lateral sides. An intake fan (not visible) may be positioned within the intake vent 28a to pull air into the interior of the case 22. An exhaust fan (not visible) may be positioned within the exhaust vent to exhaust air from the interior of the case 22. The exhaust vent, intake vent 28a, or both may include filters configured to filter air passed through the vents. Additional fans 29 may also be positioned within the interior of the case 22 to provide additional air movement where needed.

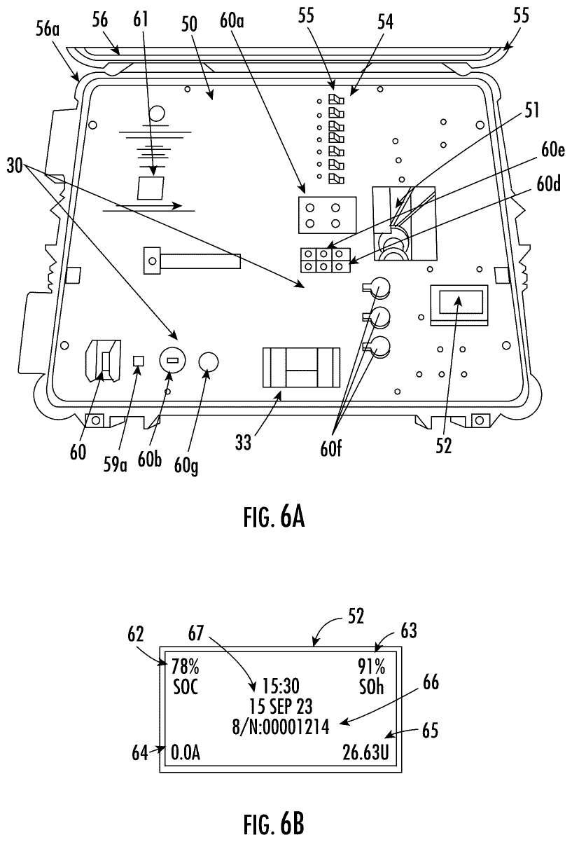

With further reference to FIGS. 6A & 6B, the power module 20 includes a local interface 50. The local interface 50 is provided along an exterior side of the case 22 and may be protected from water intrusion and unwanted access by an access door 55. In the illustrated embodiment, the access door 55 comprises a lid that may be secured to the case 22 to cover the local interface 50. The local interface 50 is configured to be exposed via operation of the access door 55. The access door is pivotable about a hinge 56 to expose and cover the local interface 50. In the covered position the access door 55 may be secured to the case 22 along one or more unhinged sides via a latching mechanism. In the covered position, the upper rim of the case 22 along the perimeter of the local interface 50 and the access door interface to provide a water resistant seal to prevent or limit water intrusion. Weather stripping 57 may be used along the interfacing perimeters. Access sensors (not visible) may be provided to detect when the access door 55 is opened, closed, or both as described herein. As described above, access may be monitored, tracked, or both by the control system 40. In the illustrated embodiment, screws secure the local interface 50 over the interior of the case 22.

The local interface 50 includes a breaker panel 82 including switches 58 engaging and disengaging breakers to components of the power module 20, ports 30, or powered devices 17 connected to the power module 20 via the ports 30, battery 24, or combination thereof. Status indicators 54 comprising LEDs are provided along the breaker panel 82 indicate the status of each breaker. Specifically, two input indicator LEDs next to the breakers to indicate to local users if AC power input is on or if donor charge input is on. While additional, fewer, or different combinations of breakers may be provided, switches 58 for breakers corresponding to the i/o port 30d, AC input port 30a, DC input port 30b (e.g., solar input port and donor input port), donor output port 30c, and power output ports 30e (which may include exterior case mounted power output ports, local interface mounted power output ports, or both, and which may be breakered individually, in groups, or both to provide tighter breaker control). The local interface 50 also includes a battery toggle switch 60, battery breaker 59a, and connection ports 60. The connection ports 60 include fiber optics connectors 60a to provide a wired data link to an onsite monitoring station 12a, controller communication port 60b to access the controller 42, access point (AP) ports 60d, radar ports 60e, output ports 30e comprising local interface mounted power output ports including output ports 60f, and accessory power output port 60g (e.g., providing 5V, 3 A). A viewing window 51 is provided to view internal communication operations within the interior of the case 22. A cable passthrough 33 is also provided. The cable passthrough 33 allows cables to be connected to the local interface 50 during normal operation while the access door 55 is in the closed position to limit opportunity for moisture intrusion and an increase security. A QR code 61 to access specifications is also provided. In the illustrated embodiment, the exterior mounted power output ports 30e are configured to couple to power devices 17 comprising radar equipment utilized to track golf balls in flight and the local interface mounted power output ports 60f are configured to couple to camera control robotics to track objects with cameras. A switch 58 for operation of camera control robotics (pan/tilt) is also provided. The power output ports 60f are configured for connecting cables between cameras and the power module 20. Camera cables may contain both Power Over Ethernet (POE)/Networking to the camera and power to a pan/tilt head operable to move powered cameras. The pan/tilt power circuit may be turned on/off via the pan/tilt breaker. The POE to the cameras can be turned on/off via automation to the network switch.

Ports 60a, 60d, and 60e may comprise communication ports 18 to provide a communication link with respect to operations of the control system 40, which may include operations of the controller 42, devices connected to the power module 20, networking, or the like. For example, one or more communication ports 18 may be configured to connect to the monitoring network 12. For instance, ports 60a may directly or indirectly provide camera feed access, access to control of camera control robotics, camera switching, or the like. Ports 60e may directly or indirectly provide communication with the operations of radar devices, which may be powered by the power module 20. Ports 60e may directly or indirectly provide communication with the control system 40 or controller 42 thereof. In one example, one or more of ports 60a, 60d, and 60e or another port connect to a communication port 18 to provide and onsite monitoring station 12a or offsite monitoring station 12b access to operations of devices connected to the ports 60a, 60d, 60e, or other ports. In another example, an onsite monitoring station 12a or offsite monitoring station 12b may interface with operations of the connected devices by directly connecting to ports 60a, 60d, 60e, or other ports.

A display 52 is also provided on the local interface 50. A magnified view of the display 52 is provided in FIG. 6B. The display 52 may be used to communicate statuses and functions of the power module 20 such as one or more of monitored data, operation conditions, or warnings, e.g., faults, as described in more detail elsewhere herein. For example, the display 52 may report battery state of charge 62, battery state of health 63, battery net current 64, battery voltage 65, or combination thereof. In some embodiments, the display 52 may additionally include power module identification number 66, date and time 67, or other monitored data, warnings, or warning messages.

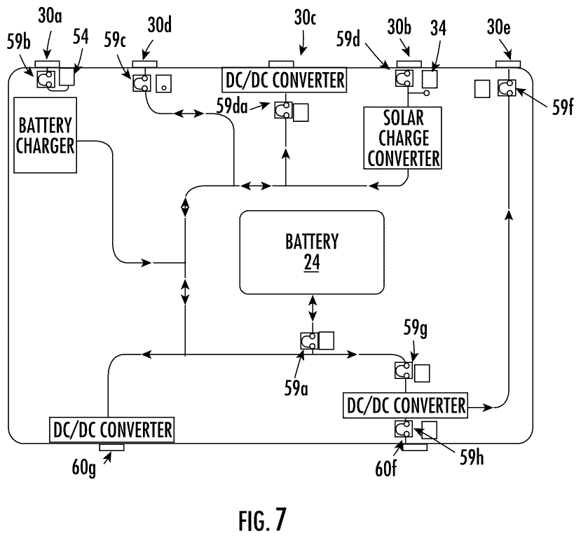

As introduced above, the power module 20 may be configured to provide flexible charging options by accepting power from multiple sources including AC power sources 31 such as single phase AC inputs (90-270 VAC). FIG. 7 provides a power flow diagram of the power module 20 according to one embodiment. The battery 24 is connected to the various ports 30 via circuit branches including breakers to protect the battery 24 and connected devices as well as for testing. It will be appreciated that other power flow or circuit configurations may be used in consideration of the application of the hybrid power system 10. While the battery circuit includes certain connected branches, in some embodiments, branches may independently connect to the battery 24. A battery breaker 59a is provided to isolate the battery 24 if needed. Breakers 59b-59h are also provided along the circuit branches from the AC input port 30a, i/o port 30b, DC output port 30c, DC input port 30d, exterior mounted power output port 30e (e.g., to supply power to a powered device such as radars), and local interface mounted power output ports 60e, 60f. The AC input port 30a may couple to an AC power source, e.g., grid power or generator, to charge the battery 24 (see, e.g., FIG. 3A) or provide power in an uninterrupted power supply configuration (see, e.g., FIG. 3E). A status indicator 54 comprising an LED circuit activity indicator may also be provided to indicate circuit activity. The i/o port 30d or parallel connection port may be used to expand capacity of the power module 20 (see, e.g., FIG. 3E). The breaker 59d along the donor output branch, including DC output port 30c, is positioned between a DC/DC converter and battery 24. The DC input port 30b operable as a solar charge input port and donor charge input port may be used to supply power generated by the solar array 80 (see, e.g., FIG. 3B) or from a donor power module 20 (see, e.g., FIG. 3C). The breaker 59e along the DC input branch is positioned prior to a solar charge controller 42. A status indicator 54 comprising an LED circuit indicator may also be provided to indicate circuit activity with respect to the DC input port 30b. Multiple breakers 59f-59h are provided along the branch supplying the exterior and local interface mounted power output ports. A first breaker 59g is positioned before a DC/DC converter to break the circuit to both output ports 30e, 60f. Both branches from the DC/DC converter to output port 30e and the output port 60f include a respective breaker 59f, 59h to separately break the respective circuit branches.

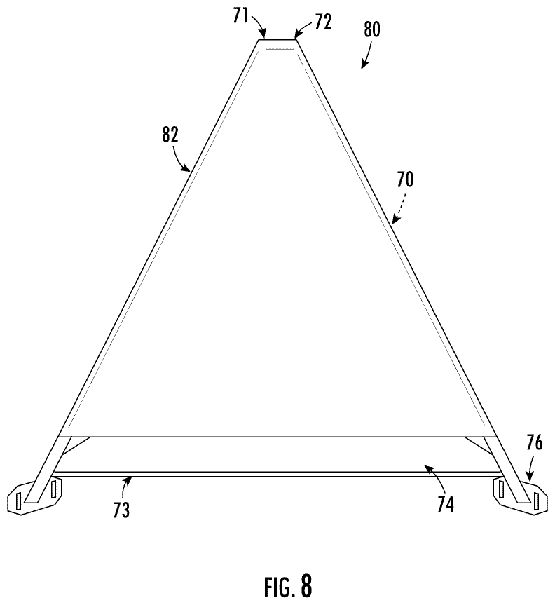

FIG. 8 provides an example solar array 80 of a hybrid power system 10 including a power module 20, such as the power module 20 described with respect to FIGS. 5A-7 or elsewhere herein, such as with respect to FIGS. 1-4. The solar array 80 comprises three panels 82 including photovoltaic cells configured to convert solar energy into DC electricity. The panels 82 comprise thin-film solar photovoltaic panels 82. The panels 82 are configured to attach together to provide a three sided pyramid arrangement. The panels 82 may be attachable together via clips, latches, snaps, zippers, hook and loop, press-fit, interference fit, magnets, or the like. The panels 82 are configured to mount on a frame 70 provided by a tripod. The tripod may include a riser post (not shown) that mounts radar, cameras, or other powered devices 17. The apex 71 of the pyramid arrangement includes an opening 72. The lower edges 73 of the panels 82 may be raised with respect to a supporting surface, a breathable fabric 74 may be used along the lower edges 73, or both to aid in air circulation between the supporting surface, through the interior of the solar array 80 and the apex 71. The solar array 80 is sized such that the power module 20 may be partially enclosed within the interior of the pyramid. The frame 70 may include pivotable feet 76 to adjust to varied mounting surfaces. This omni directional array shape allows for quick and easy installation, without need to move or redirect panels 82 during daylight operation, and while hiding the power module 20.

The power module 20 described with respect to FIGS. 5A-7 includes a control system 40 and controller 42 similar to that described above with respect to FIG. 1 and elsewhere herein. For example, with reference to FIG. 1, the control system 40 may be configured to perform one or more of temperature monitoring and control, battery monitoring and management, moisture monitoring, water remediation, case security, local communication, remote communication, or combination thereof. The controller 42 may be housed within the case 22 and include one or more control boards, a processor, and memory storing instructions that when executed by the processor perform operations of the controller 42. In one example, the controller 42 may comprise a single board computer, such as a Raspberry Pi. The control system 40 may include sensors 44 configured to detect operation conditions with respect to the power module 20, solar array 80, or both. The sensors 44 may be configured to measure one or more of input current, output current, battery charge, battery voltage, battery temperature, case humidity, or local interface 50 access. In one example, the control system 40 monitors battery conditions selected from one or more of state of charge, battery health, charge current, discharge current (e.g., current, minimum, maximum), solar wattage generated, amp draw of a load, battery temperature (e.g., current, minimum, maximum), board temperature, voltage (e.g., current, total, individual cells, minimum, maximum), discharge rate, time to discharge, or combination thereof. In one example, the controller 42 includes a Controller Area Network (CAN bus) configured to perform one or more of the above battery monitoring operations. As described herein, such data may be transmitted to or otherwise accessible to a monitoring network 12.

In one embodiment, the control system 40 is configured to analyze the monitored data and determine if the data alone or together with additional monitored data requires action. For example, the control system 40 may be programmed to take action upon the occurrence of a defined trigger condition. The actions may include engaging fans 29 to reduce temperature or humidity when the moisture level or temperature exceeds a predefined threshold, output warnings, warning messages, or combination thereof. Warning may be notifications output locally via a local interface 50, which may include output of warning sounds, activation of warning lights, output of warning messages on the display, or combination thereof. In some embodiments, remote notifications, which may include warnings, may be output to staff via apps, devices, and other non-local notification solutions. The warning may identify the trigger condition, parameters triggering the condition, recommended actions to be taken, or combination thereof. In one example, warnings may provide instructions to respond to the condition, such as open drain plug 27, engage fans 29, shut down operation with respect to one or more powered or connected devices, engage breaker circuits, or combination thereof. In one example, the control system 40 may include temperature sensors that detect temperatures associated with the battery 24. Based on monitored temperatures and defined temperature conditions, the controller 42 may engage fans 29 to increase air circulation and reduce temperatures. The control system 40 may be configured to engage one or more protection circuits, which may include breakers 59a-59h or protection circuits with respect to battery charge or discharge, to protect the battery 24 and users from dangerous conditions related to cell voltages, temperatures, and current flowing in or out of the battery 24. The controller 42 may include or otherwise be operable to one or more of monitor, engage, or disengage protection circuits. The battery monitoring and management operations may be designed to promote healthy cycling at the individual cell level. For instance, when all operating conditions are satisfactory, current can flow in/out of the battery cells. However, if temperature, voltage, or current is outside of the defined operation condition limits, the controller 42 may engage protection circuits and remove the cells from service, disabling the battery 24 at its terminals until proper operating conditions are restored. This may include engaging fans 29 to circulate air and reduce temperature, directing current to specific cells, or the like.

The control system 40 may be configured to log monitored operational conditions over time. The control system 40 may time stamp monitored operational, which may include operational metrics, for analysis or review. The hybrid power system 10 may include or incorporate a monitoring network 12 including onsite monitoring stations 12a, offsite monitoring stations 12b, or both. The hybrid power system 10 may be configured to provide access to the operations of the control system 40 to the monitoring network 12 via wired or wireless communication via a communication network 12. For example, the control system 40 may provide a remote interface 78 wherein monitoring stations may view monitored data, operational conditions, statuses, or the like. In a further example, the remote interface 78 may provide access to one or more operations of the controller 42, such as one or more of the operations of the controller 42 described herein.

The control system 40 may be configured to detect access, track access, or both with respect to the local interface 50 by utilizing sensors 44 to detect when the access door is opened, closed, or both. Non-limiting examples of sensors 44 to detect access include motion sensors, touch sensors, weight sensors, mechanical sensors, and magnets. In one embodiment, current access status, tracked access events, or both may be transmitted or otherwise made available via the remote interface 78 to the monitoring network 12.

Further to the above, the control system 40 may be configured to transmit, via the communication port 18, one or more components of the monitored data to the communication network 12 to report the same. As introduced above, the monitored data may be transmitted or accessed by the monitoring network 12. With further reference to FIG. 9, a monitoring network 12 may include one or more onsite monitoring stations 12a, one or more offsite monitoring stations 12b, or both in data communication with the control system 40 via wired or wireless technology through a communication network 12. Onsite generally means in close proximity, such as on or around a golf course 17a, 17b or other grounds the hybrid power system 10 is operating. Offsite generally means anywhere in the world outside onsite. An onsite monitoring station 12a, offsite monitoring station 12b, or both may monitor a plurality of hybrid power systems 10. For example, an offsite monitoring station 12b may be configured to receive monitored data from hybrid power systems 10 positioned around one or more golf courses 17a, 17b located at one or more geographic locations 19a, 19b. Monitoring stations 12a, 12b may be configured to receive or access monitored data for analysis. As introduced above, the control system 40 may provide a remote interface 78 accessible by monitoring stations 12a, 12b to some or all of the monitored data. For instance, the remote interface 78 may provide access to statuses such as state of charge, battery health, battery or system faults, port status, network status, or other statuses. The remote interface 78 may also provide access to one or more operational conditions, which may include operational functions, such as those described herein. In a further example, the control system 40 may be configured to provide access to one or more of the operations of the controller 42 described herein via the remote interface 78. For example, using the remote interface 78, monitoring stations 12a. 12b may transmit instructions to control systems 40 to take specific actions, such as modify power output, engage or disengage breaker circuits or protection circuits, shut down or modify power to one or more ports 30, run status checks, transmit current or historical statuses, modify power output, or other suitable action. Monitoring stations 12a/12b may contact local personnel to inspect, test, confirm status, shut down, or take another action with respect to a power module 20 based on monitored data. In various embodiments, the monitoring network 12 may access operations of the control system 40, including monitoring, controlling, or both, operations of connected devices, such as radar and cameras, via communication port 18, which may include one or more of ports 60a, 60d, or 60e.

It is to be appreciated that the components and operations of the control system 40 as well as the hybrid power system 10 may be selected based on the desired use of the hybrid power system 10. Thus, the features and operations of the hybrid power system 10 and control system 40 described herein may be selected by those skilled in the art based on the present description to achieve the desired hybrid power system 10 configuration for the desired application. The various features and operations of the hybrid power system 10 described herein may be optionally included and the specific configurations described herein are not reflective of essential selection or arrangement of components or features.

In one embodiment, a method of providing power to a golf tournament or other event comprises positioning a power module within an enclosure formed by a solar array. The solar array may be arranged as described herein. For example, the solar array may partially or completely enclose the power module. The solar array may enclose the power module along sides. The solar array may be arranged in a pyramid formation having three or more sides. The solar array may be similar to that described with respect to FIG. 4 or FIG. 9. The power module may comprise a power module as described herein, including any combination of features described herein.

In one embodiment, method of monitoring power systems providing onsite power to a golf tournament of other event includes communicating with one or more power systems to receive monitored data collected by the control system of the power system. The method may also include causing the controller of the power system to perform one or more actions, such as any of the actions described herein. In a further embodiment, the monitoring includes monitoring a plurality of power systems from an offsite or onsite monitoring station. The power system may comprise a hybrid power system as described herein.

At least a portion of the systems, methodologies, and techniques described with respect to the exemplary embodiments may incorporate a machine, such as, but not limited to a computer system or other computing device within which a set of instructions, when executed, may cause the machine to perform any one or more of the methodologies or functions discussed above. The machine may be configured to facilitate various operations conducted by the systems. For example, the machine may be configured to, but is not limited to, assist the systems by providing processing power to assist with processing loads experienced in the systems, by providing storage capacity for storing instructions or data traversing the systems, or by assisting with any other operations conducted by or within the systems. In some embodiments, the machine may operate as a standalone device. In some embodiments, the machine may be connected (e.g., using communications network, another network, or a combination thereof) to and assist with operations performed by other machines and systems, such as, but not limited to, the control system 40, powered devices 17, monitoring network 12, onsite monitoring stations 12a, offsite monitoring stations 12b, databases, any other system, program, and/or device, or any combination thereof. The machine may be connected with any component in the systems. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system may include a processor (e.g., a central processing unit (CPU), a graphics processing unit (GPU), or both), a main memory and a static memory, which communicate with each other via a bus. The computer system may further include a video display unit, which may be, but is not limited to, a liquid crystal display (LCD), a flat panel, a solid state display, or a cathode ray tube (CRT). In one example, the video display unit comprises an e-link display, such as display 52. The computer system may include an input device, such as, but not limited to, a keyboard, a cursor control device, such as, but not limited to, a mouse, a disk drive unit, a signal generation device, such as, but not limited to, a speaker or remote control, and a network interface device. The disk drive unit may include a machine-readable medium on which is stored one or more sets of instructions, such as, but not limited to, software embodying any one or more of the methodologies or functions described herein, including those methods illustrated above. The instructions may also reside, completely or at least partially, within the main memory, the static memory, or within the processor, or a combination thereof, during execution thereof by the computer system. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, certain methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium containing instructions so that a device connected to the communications network, another network, or a combination thereof, can send or receive voice, video or data, and communicate over the communications network, another network, or a combination thereof, using the instructions. The instructions may further be transmitted or received over the communications network, another network, or a combination thereof, via the network interface device. The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure. The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

1. A hybrid power system for providing power to a golf tournament,
the system comprising:
a power module comprising:
a case having an interior space for housing a battery,
a plurality of output ports for supplying electrical current to devices electrically coupled to the ports, and
one or more input ports for receiving a supply of electrical current to charge the battery,
a control system configured to monitor statuses and operating conditions of the power module and comprising a controller to execute operations of the power module;
a communication port configured for electronic communication with a communication network;
a remote interface accessible via the communication network and configured to interface a monitoring station with the control system and receive or access monitored data collected by the control system related to the operations of the power module; and
a solar array configured to couple to one of the one or more input ports.

2. The system of claim 1, wherein the solar array is configured to position over and at least partially enclose the power module.

3. The system of claim 1, wherein the solar array comprises three panels that wrap around legs of a tripod, and wherein the power module positions within an area defined between the legs of the tripod.

4. The system of claim 1, wherein the remote interface is accessible via wireless communication to remotely view monitored data comprising statuses and operating conditions related to the operation of the power module.

5. The system of claim 4, wherein the statuses and operating conditions comprise one or more of an environmental condition, operational state, load, battery capacity, or security access log.

6. The system of claim 1, wherein the control system includes predefined trigger conditions that trigger actions based on monitored operating conditions.

7. The system of claim 6, wherein the actions comprise transmitting a notification of the operating condition triggering the action to the monitoring station.

8. The system of claim 1, wherein the remote interface is accessible via wireless communication by the monitoring station to remotely control operations of the controller.

9. The system of claim 8, wherein the controller is operable to engage breakers within battery input and output power circuits.

10. The system of claim 9, wherein the controller is further operable to one or more of modify electrical current output, redirect electrical current to one or more output ports, redirect charging current to one or more battery cells, or initiate and discontinue operation of a fan located within the case or a vent thereof.

11. The system of claim 1, wherein the control system includes one or more sensors comprising one of a moisture sensor or humidity sensor configured to detect a moisture level within the case.

12. The system of claim 11, wherein the sensors comprise a temperature sensor configured to measure temperature within the case, temperature of power module hardware within the case, or both.

13. The system of claim 1, further comprising a fan located with the case or at a vent thereof, wherein the controller is configured to initiate operation of the fan when the moisture level or temperature exceeds a predefined threshold.

14. The system of claim 1, further comprising a local interface positioned on the case, wherein the local interface includes controls for engaging or disengaging breakers within battery input and output power circuits.

15. The system of claim 14, wherein the local interface includes a view window for viewing a network activity indicator light.

16. A monitoring network for monitoring a plurality of mobile power modules positioned around a golf course to provide power to cameras and radar, the monitoring network comprising:
a monitoring station off-site of the golf course configured to wirelessly communicate with the plurality of power modules to receive or access monitored data with respect to the power modules, remotely control one or more operations of the power modules, and receive notifications, wherein each power module comprises:
a case having an interior space for housing a battery,
a plurality of output ports for supplying electrical current to devices electrically coupled to the ports,
one or more input ports for receiving a supply of electrical current to charge the battery, and
a control system configured to monitor statuses and operating conditions of the power module and comprising a controller to execute operations of the power module;
a communication port configured for electronic communication with a communication network;
a remote interface accessible via the communication network and configured to interface the monitoring station with the control system; and
a solar array configured to couple to one of the one or more input ports.

17. The monitoring network of claim 16, wherein the monitored data comprises statuses and operating conditions related to the operation of the respective power modules.

18. The monitoring network of claim 17, wherein the statuses and operating conditions comprise one or more of an environmental condition, operational state, load, battery capacity, or security access log.

19. A method of providing remote power on a golf course during a golf tournament, the method comprising:
providing a plurality of power modules for positioning around the golf course;
wirelessly communicating with a control system of each of the power modules to receive or access monitored data relating to the operation of the respective power modules;
remotely controlling one or more power input or power supply operations of at least one of the power modules via communication with the control system of the at least one of the power modules, wherein the power module comprises:
a case having an interior space for housing a battery,
a plurality of output ports for supplying electrical current to devices electrically coupled to the ports,
one or more input ports for receiving a supply of electrical current to charge the battery,
a control system configured to monitor statuses and operating conditions of the power module and comprising a controller to execute operations of the power module;
a communication port configured for electronic communication with a communication network;
a remote interface accessible via the communication network and configured to interface the with the control system; and
a solar array configured to couple to one of the one or more input ports.

20. The method of claim 19, wherein the monitored data comprises statuses and operating conditions related to the operation of the respective power modules, and wherein the statuses and operating conditions comprise one or more of an environmental condition, operational state, load, battery capacity, or security access log.
